(19) United States
(12) Patent Application Publication
(10) Pub. No.: US 2004/0064218 A1
(43) Pub. Date: Apr. 1, 2004

(54) Supporting bracket for external power-management controller and/or at least one external sensor device that cooperate to reduce electrical power consumption of an appliance

(76) Inventors: David J. Schanin, Denver, CO (US); Marc Geman, Denver, CO (US)

Correspondence Address: Gordon & Jacobson, P.C., 65 Woods End Road, Stamford, CT, 06905, US

(21) Appl. No.: 10/259,068

(22) Filed: Sep. 27, 2002

(51) Int. Cl. G05D 17/00

(52) U.S. Cl. 700/286

(57) ABSTRACT

A power-management control subsystem, which is external to an appliance, automatically couples/decouples the power input port of the appliance to/from a power source in response to control signals provided by sensor(s) and possibly in response to additional control signals. A support member is provided that has a plurality of sections including a first section and a second section. The first section provides mechanical support to the external power-management control subsystem. The second section provides mechanical support to the sensor(s). Preferably, the support member is a unitary flat piece of hard metal that is bent to form the plurality of sections. In addition, the first section and second section may extend along parallel directions such that the first section can be affixed to the back surface of the appliance (preferably with a releasable VELCRO strip assembly). In this manner, the first section (and the power-management control subsystem supported thereon) is disposed along the back surface of the appliance, while the second section (and the sensor(s) supported thereon) is disposed above the top surface of the appliance. In addition, the signals output from sensor(s) and provided to the power-management control subsystem may be carried by electrical wiring affixed to the support member.

### BACKGROUND OF THE INVENTION

1. Technical Field

The present invention relates to electrical systems and, more particularly, to electrical systems for reducing power consumption by electrical appliances.

2. Related Art

Recent events have given urgency to what has always been a good idea: energy conservation. Energy conservation can be implemented simply by turning off power from appliances that are not in use. While power control can be done manually, e.g., people can turn off appliances when they are done using them and turn off lights as they leave a room, automated power control plays an important role in energy conservation.

Timers can be used to control power delivery. For example, business lights can be turned on automatically at the start of a business day and turned off automatically at its close. Alternatively, timers can control the duration for which an appliance is active. For example, a timer might turn off a hot air hand dryer after a fixed time; anyone wanting more time can reset the hand dryer. Many appliances, such a printers, enter a low-power “sleep” mode after a set period of non-use.

Ambient-light sensors can be used to control certain appliances. For example, street lamps can be activated in low light conditions, and deactivated when morning brings sufficient light that the artificial illumination is not required.

Motion sensors, such as occupancy sensors, can be used to supply power only when people are present. Security lights often combine ambient-light detection and motion detection. During the day, the lights remain off regardless of motion in their vicinity; however, at night, motion triggers the lights on.

Vending machines, particularly those that are refrigerated, pose special problems when it comes to energy conservation. Typically, a vending machine owner-operator places a vending machine in operation on the premises of another, and visits as necessary to refill the vending machine. The owner of the premises typically pays for the electricity consumed by the vending machine, and thus may have the biggest interest in saving power; however, the premises owner may be limited to unplugging the vending machine to save power during time of low usage.

However, unplugging or switching off a refrigerated vending machine can have the undesirable consequence that the vending items may warm up. In extreme cases, this may cause items to spoil. However, even where spoilage is not a problem, customers might have the unpleasant experience of, for example, a warm soda if they purchase soon after the vending machine is turned on. Also, unplugging or switching off a vending machine risks losing sales and customers.

U.S. Pat. No. 6,243,626, commonly assigned to assignee of the present invention, herein incorporated by reference in its entirety, discloses an appliance (e.g., vending machine) with an external power-management control subsystem that automatically couples/decouples the appliance from an electric power source (e.g., wall outlet) in response to control signals provided by one or more sensors/timing circuits. For example, a current sensor, time-of-day circuitry, and occupancy motion sensor, and timer circuitry can be used as inputs to a controller, which is programmed to automatically decouple the appliance from the wall outlet as follows. When the current level sensed by the current sensor is below a low threshold level, the occupancy motion sensor does not sense occupancy, and the time-of-day circuitry indicates the time is “off-hours”, the timer is set to a predetermined probationary period (for example, ½ hour). During this probationary period, the inputs values are periodically evaluated to determine whether shutdown is appropriate. During such periodic evaluations, if shutdown is determined not to be appropriate, the probationary period is aborted. Yet, if during such evaluations, it is determined that shutdown is appropriate and the probationary period lapses, the controller automatically decouples the appliance from the wall outlet, thereby “shutting down” the appliance.

These same inputs (and other inputs) can be used by the controller to automatically couple the appliance to the wall outlet, thereby activating the appliance. For example, any one of the following conditions can trigger the controller to automatically couple the appliance to the wall outlet: lapse of a countdown period provided by the timing circuitry; the occupancy motion sensor senses occupancy; the time-of-day circuitry indicates the time is “in-business-hours”; a temperature sensor indicates the ambient temperature level has risen to a level that requires cooling/activation of the appliance.

One issue regarding external power-management of an appliance is the ease of installation of the external power-management controller and the supporting sensor(s)/circuitry. Typically, the external power-management subsystem is mounted with screws to a mounting plate that is affixed to a wall adjacent or behind the appliance. Similarly, the supporting sensor(s) (such as and occupancy motion sensor and/or temperature sensor) is typically mounted with screws to a mounting plate that is affixed to a wall adjacent or behind the appliance. Such installations are time-consuming and may be prone to error. For example, the installer may incorrectly orient the occupancy sensor so that it fails to accurately sense occupancy near the appliance vending machine. In another example, the installer may position the temperature sensor near the hot-air exhaust duct of the appliance vending machine so that the temperature sensor inaccurately senses the ambient temperature. Thus, there remains a need in the art for external power-management control of an appliance that provides power conservation in addition to easy and error-free installation.

### SUMMARY OF THE INVENTION

It is therefore an object of the invention to conserve energy usage by vending machines.

It is another object of the invention to provide external power-management control of an appliance in a manner that affords power conservation in addition to easy and error-free installation.

It is another object of the invention to provide external power-management control of an appliance in a manner that affords quick and easy installation without tools.

It is a further object of the invention to provide external power-management control of an appliance in a manner that affords proper placement of components (including control subsystems and associated sensors) used therein.

It is an additional object of the invention to provide structural support for components that provide external power-management control of an appliance in a manner that affords easy, inexpensive, and error-free installation of such components.

It is also an object of the invention to provide structural support for components that provide external power-management control of an appliance in a manner that affords quick and easy installation of such components without tools.

It is still another object of the invention to provide structural support for components that provide external power-management control of an appliance in a manner that affords proper placement of such components.

In accord with these objects, which will be discussed in detail below, a power-management control subsystem, which is external to an appliance, automatically couples/decouples the power input port of the appliance to/from a power source in response to control signals provided by sensor(s) and possibly in response to additional control signals. A support member is provided that has a plurality of sections including a first section and a second section. The first section provides mechanical support to the external power-management control subsystem. The second section provides mechanical support to the sensor(s).

According to one embodiment of the present invention, the support member is a unitary flat piece of hard metal that is bent to form the plurality of sections. In addition, the first section and second section may extend along parallel directions such that the first section can be affixed to the back surface of the appliance (preferably with a releasable velcro strip assembly). In this manner, the first section (and the power-management control subsystem supported thereon) is disposed along the back surface of the appliance, while the second section (and the sensor(s) supported thereon) is disposed above the top surface of the appliance. These features enable quick and tool-less installation of the external power-management control system and the sensor(s) mechanically supported by the support member.

In addition, the signals output from sensor(s) and provided to the power-management control subsystem may be carried by electrical wiring affixed to the support member.

According to other embodiments of the present invention, the second and third sections of the support member may be omitted. In such a configuration (which may be used for daisy-chaining additional external power-management control subsystems to control power supplied to a bank of appliances), the first section of the support member provides mechanical support to the external power-management control subsystem. In addition, the first section can be releasably affixed to the back surface of the appliance (preferably with a releasable velcro strip assembly) for quick and tool-less installation of the external power-management control subsystem supported by the first section.

According to alternate embodiments of the present invention, the power-management control subsystem may be integral to the appliance. In such a configuration, a support member is provided that has a plurality of sections including a first section and a second section. The first section is releasably affixed to the appliance. The second section provides mechanical support to sensor(s), which provide control signals to the power-management control subsystem for automatic coupling/decoupling of the power input port of the appliance to/from a power source in response to the control signals provided by sensor(s). In addition, the first section and second section may extend along parallel directions such that the first section can be affixed to the back surface of the appliance (preferably with a releasable velcro strip assembly). In this manner, the first section is disposed along the back surface of the appliance, while the second section (and the sensor(s) supported thereon) is disposed above the top surface of the appliance. These features enable quick and tool-less installation of the sensor(s) mechanically supported by the support member. Preferably, the support member is a unitary flat piece of hard metal that is bent to form the plurality of sections.

Additional objects and advantages of the invention will become apparent to those skilled in the art upon reference to the detailed description taken in conjunction with the provided figures.

### BRIEF DESCRIPTION OF THE DRAWINGS

FIG. 1 is an oblique view of an exemplary embodiment of an external power-management control system 1 that controls the coupling of an appliance to a power source in accordance with the present invention.

FIG. 2 is a partial side view of the external power-management control system of FIG. 1.

FIG. 3 is a schematic illustration of an exemplary power-management control system in accordance with the present invention.

FIG. 4 is a flow chart of an exemplary power-management control scheme carried out by the power-management control system of FIG. 3.

### DESCRIPTION OF THE PREFERRED EMBODIMENTS

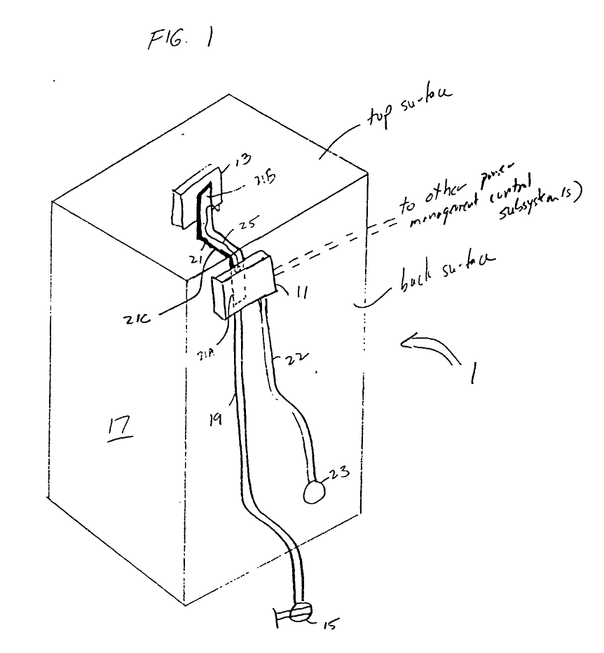

Turning now to FIG. 1, a power-management control subsystem 11 and at least one sensor 13 (one shown) cooperate to automatically manage supply of power from an electric power source 15 (e.g., wall outlet as shown) to an appliance vending machine 17. Power cord 19 electrically couples power-management control subsystem 11 to the power source 15, and power cord 22 electrically couples power-management control subsystem 11 to the power input port 23 of the appliance vending machine 17. The output of the sensor(s) 13 is operably coupled to the power-management control subsystem 11 preferably via wiring 95 as shown. Alternately, a wireless data communication link may be used to couple the output of the sensor(s) 13 to the power-management control subsystem 11.

The power-management control subsystem 11, which is external to the appliance vending machine 17, automatically couples/decouples the power input port 23 of the appliance vending machine 17 to/from the power source 15 in response to control signals provided by sensor(s) 13 (and possibly in response to additional control signals, for example provided by timing circuitry, time-of-day circuitry, and a current sensor as described herein in detail). The sensor(s) 13 may include a motion-based occupancy sensor (preferably realized as a passive infrared motion detector) and/or a temperature sensor that senses ambient temperature.

The power-management control subsystem 11 may be adapted to act as a master controller by forwarding sensor status information (derived from the output of the sensor(s) 13) to other power-management control subsystems (slave controller(s)) operably coupled thereto as shown in FIG. 1, which is typically found in applications where a bank of vending machines are co-located in a facility. Preferably, the master power-management control subsystem 11 forwards such sensor status information by asserting a signal which is then electrically isolated, typically using an opt-coupler, before connection to the slave power management control system(s). Isolating this signal eliminates potential differences between the master and slave power-management control subsystems, which occur frequently since the two subsystems will likely be plugged into outlets on separate electrical circuits. Repeating the sensor status information to the slave power-management control subsystem(s) allows each slave power-management control subsystem to automatically manage supply of power from an electric power source to an appliance vending machine(s) operably coupled thereto without the need for sensors, thereby reducing the cost of the overall power management control system. Also, this repeating function allows the master power-management control subsystem (and all slave power-management control subsystem that repeat the sensor status information), to delay such sensor status information for a small time period (e.g., few seconds) so that when occupancy is detected, the bank of appliance vending machines controlled by the chain of power-management control subsystems will power up sequentially and not in unison, which prevents electrical surges that might trip circuit protection devices such as circuit breakers.

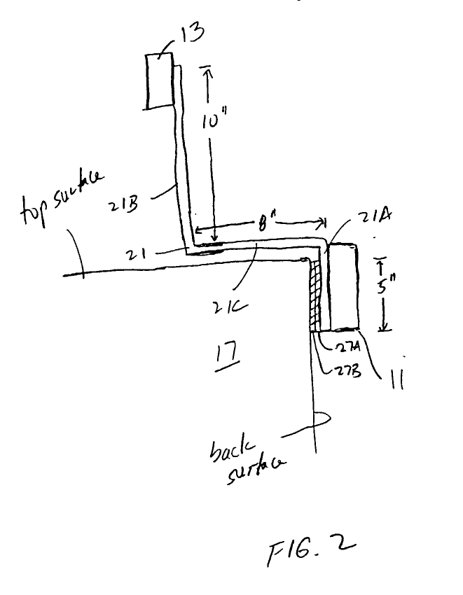

As shown in FIGS. 1 and 2, a support member 21 is provided that has a plurality of sections (for example, three shown) including a first section 21A, a second section 21B and a third section 21C. The first section 21A provides mechanical support to the external power-management control subsystem 11. The second section 21B provides mechanical support to the sensor(s) 13. Preferably, the width of support member 21 is substantially smaller than its length. For example, the length of the support member 21 in FIG. 2 (e.g., the cumulative length of its sections) is approximately 24 inches, while the width of each section is approximately 2 inches. Preferably, the support member 21 is a unitary flat piece of hard metal that is bent to form the plurality of sections.

The power-management control subsystem 11 may be removably affixed to section 21A of the support member 21 through the use of a mounting bracket, which allows its easy removal if repair is needed. Alternately, the power-management control subsystem 11 may be permanently affixed to section 21A of the support member 21 using standard screws.

The sensor(s) 13 may be affixed to section 21B of the support member 21 through the use of a mounting bracket, which allows its easy removal if repair is needed. Alternately, the sensor(s) 13 may be permanently affixed to section 21B of the support member 21 using standard screws.

As shown in FIG. 2, the first section 21A and the second section 21B preferably extend along parallel directions. In addition, the first section 21A preferably is releasably affixed to the appliance 17, for example by mating industrial strength VELCRO strips 27A and 27B that are bonded to the first section 21A and to the appliance 17, respectively. Preferably, the VELCRO strip 27B is bonded to the back surface of the appliance 17 (near the top surface) to enable the support member 21 to extend along the back surface (section 21A), extend along the top surface (section 21C) and extend vertically (section 21B) as shown. In this manner, the first section 21A (and the power-management control subsystem 11 supported thereon) is disposed along the back surface of the appliance vending machine 17, the third section 21C is disposed on or atop the top surface of the appliance 17, while the second section 21B (and the sensor(s) 13 supported thereon) is disposed above and generally perpendicular to the top surface of the appliance vending machine 17. The dimensions (and corresponding position) of the second section 21B (and the sensor(s) 13 supported thereon) is designed to provide accurate sensing (for example, accurate occupancy sensing and/or accurate temperature sensing).

In addition, the signals output from sensor(s) 13 and provided to the power-management control subsystem 11 are preferably carried by electrical wiring 25 affixed to the support member 21 as shown in FIG. 1.

The backside of section 21B (which supports sensor(s) 13) preferably carries a warning label (not shown) that provides an indication not to block the sensor(s) 13. Also, the power cord 19 may include a tag (not shown) coupled thereto which indicates that certain components (e.g., the power-management control subsystem 11, sensor(s) 13, and supporting member 21) belong to the facility and are not to be removed therefrom if the appliance vending machine 17 is removed and/or replaced. The tag may also provide instructions that such components should be provided to the facility manager.

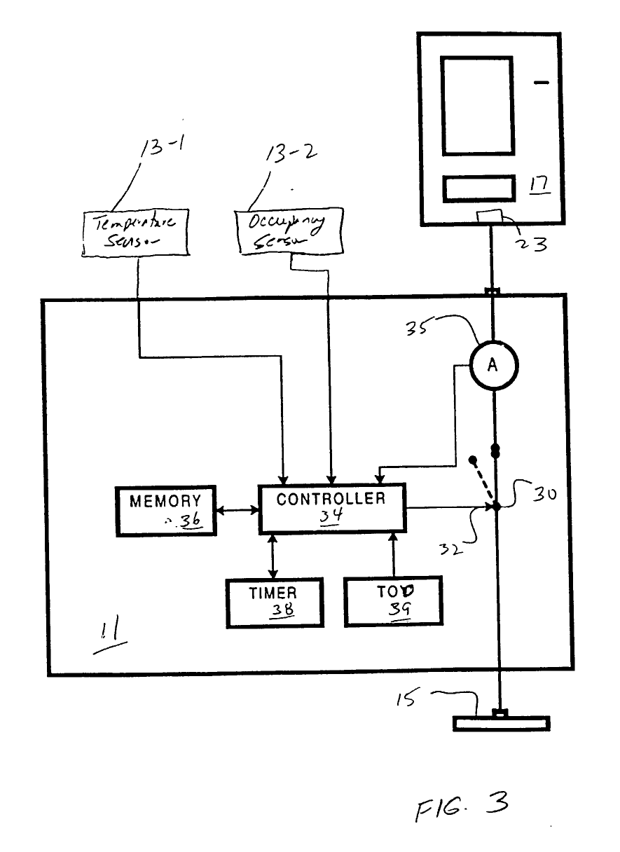

FIG. 3 is a schematic diagram of an exemplary power-management control system 1. The power-management control subsystem 11 is disposed electrically between an electrical power source (e.g., wall socket) 15 and an appliance vending machine 17. The subsystem 11 includes a switch 30 that, when in its “ON” condition, electrically couples the input power port 23 of the appliance vending machine 17 to wall socket 15. In its “OFF” condition, indicated in dash in FIG. 3, switch 30 causes the input power port 23 of the appliance vending machine 17 to be decoupled electrically from the power source 15. A supporting member (not shown) includes sections that mechanically support subsystem 11 and sensor(s) 13 as described above with respect to FIGS. 1 and 2.

Power switch 30 has a control input 32 that is coupled to a controller 34. Through its connection to control input 32, controller 34 controls when switch 30 is in its ON condition and when it is in its OFF condition. Controller 34 determines the appropriate condition for switch 30 at any given time as a function of present and past readings from a current sensor 35, a temperature sensor 13-1, an occupancy sensor 13-2, and a time-of-day circuit 39 (an absolute time sensor). In addition, subsystem 11 includes a timer 38 for elapsed time indications and a random-access memory 36 for storing data for use by controller 34. Thus, each of these devices is coupled to the controller 34 so as to provide respective parameters readings thereto.

Alternative embodiments of the invention include a current sensor but omit one or more of the temperature sensor 18, the occupancy sensor 20, and the time-of-day circuit 39. Also, some embodiments include a time-of-day circuit that is used to provide data from which a controller calculates elapsed time, thus dispensing with the need for a separate timer circuit 38.

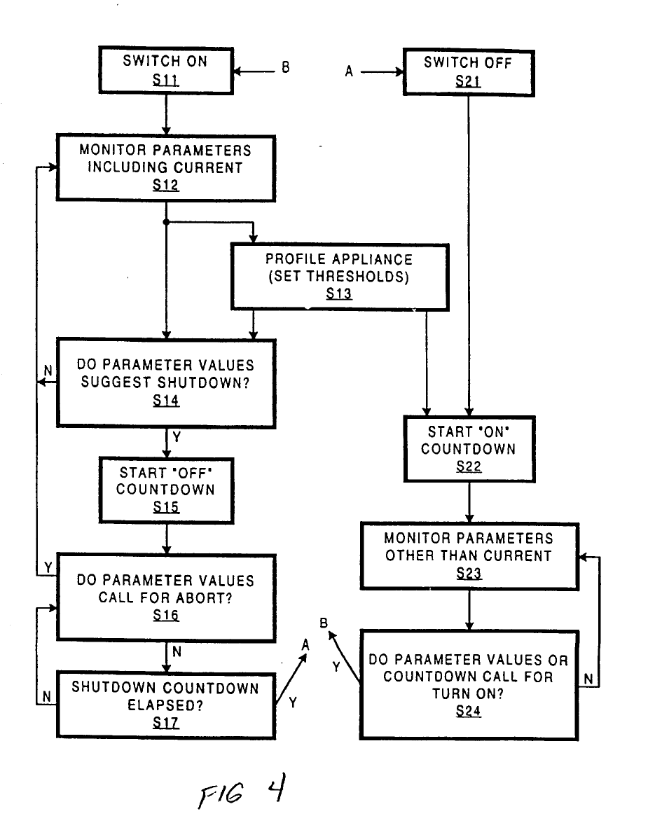

FIG. 4 is a flow chart illustrating an exemplary power-management control scheme carried out be the power-management control system 1 of FIG. 3. In block S11, switch 30 is placed in its ON condition so that power is supplied from power source 15 to the appliance vending machine 17. At block S12, current, temperature, occupancy, and absolute time parameters are monitored. The monitoring is ongoing even as subsequent blocks are performed. In block S13, data collected in block S12 is used to build a profile of appliance vending machine 17. For example, current minima and maxima are recorded and stored by controller 34 in memory 36. Current thresholds are calculated by controller 34 as a function of the minima and maxima and are also stored in memory 36.

These thresholds are used to determine whether or not a shutdown is in order. Specifically, a low threshold is calculated that indicates that the appliance vending machine 17 is not being used and is not in a compressor cycle. A high threshold is calculated that indicates when the appliance vending machine 17 is in use or in a compressor cycle. Between the high and low thresholds is an indeterminate or transition range that introduces hysteresis into the determination of when to remove power from the appliance vending machine 17.

In addition, the duty cycles of current peaks associated with compressor cycles are collected and are correlated with temperature. This data can be used to determine a maximum shutdown time for the appliance vending machine 17. For example, if the compressor duty cycle was very long before shut down, the shutdown time of appliance vending machine 17 can be extended. In another example, if the ambient temperature falls after shut down, the shutdown time can be extended.

Once sufficient data has been collected to form an initial profile, the data collected in block S12 can be used in block S14 to determine whether to maintain switch 30 in the ON condition or switch it into the OFF condition (thereby shutting down the appliance vending machine 17).

For example, if the current level identified by current sensor 35 is high (indicated usage or a compressor cycle), if the occupance sensor 13-2 determines that occupancy is positive, or if the absolute time provided by time-of-day circuit 39 is during “business hours”, the appliance vending machine 17 is not shut down. In this case, operations return to the monitoring block S12. However, if at block S14, the current level identified by current sensor 35 is below the low threshold, the occupancy sensor 13-2 determines that occupancy is negative, and the absolute time provided by time-of-day circuit 39 is during “off hours”, then timer 38 is set for a probationary period (e.g., half an hour time period) at block S15. During this probationary period, the present values of the parameters are evaluated at block S16 to determine whether any parameter changes to a value indicating that shut down is not appropriate. If there is such a change, the countdown is aborted and operations returns to monitoring in block S12. More specifically, if the current exceeds the upper threshold, occupancy becomes positive, or the time-of-day becomes “business hours”, the probationary countdown is aborted. As long as the parameter values are within the range for which shut down is appropriate, the elapsed time is checked at block S13. If the countdown has not elapsed, operation returns to evaluation in block S16. If all parameters continuously indicate that a shut down is in order at repeated iterations of block S16 and if at one iteration of block S13 an indication is received that the probationary period has elapsed, then operations jump to block S21 at which controller 34 forces switch 30 to its OFF condition, thereby shutting down the appliance vending machine 17. An alternative to the illustrated control scheme is simply to delay shut down until the current goes low.

The control scheme of FIG. 4 provides for block S22, wherein timer 38 is set to a countdown period. When this countdown period elapses, switch 30 is set to its ON condition (if it is not already ON) so that power is supplied to appliance vending machine 17. For example, either long compressor cycles just prior to shut down or a high ambient temperature during shut down may call for the appliance vending machine 17 to be powered on so that the contents can be cooled. The shut down period can be calculated by controller 34 based on profile data collected at block S13. If such action is not necessary, timer 38 is not activated at block S22.

During shut down, parameters other than current are monitored at block S23. If at block S24 it is found that the parameter values call for activating the appliance vending machine 17, operations jump to block S11 and switch 30 is set in its ON condition. Otherwise, operations return to block S23.

In block S24, the occupancy sensor 13-2 determining that occupancy is positive can cause activation. Also, transition of the absolute time provided by time-of-day circuit 39 into “business hours” can cause activation. Finally, an increase in temperature measured by temperature sensor 13-1 to an ambient temperature level requiring cooling of contents can cause activation.

By monitoring current, the control scheme of FIG. 4 gathers and maintains information about the appliance that can permit more intelligent power-management. For many appliances, suddenly withdrawing power during a period of high current use is undesirable, whether the high current is due to usage or a internally initiated procedure. The data regarding variation of current over time can be used to profile the appliance in a number of ways.

Information can be gathered regarding peak and minimum currents so that the power-management control scheme can autocalibrate. In addition, the duration of the maxima and minima can be used to provide a duty-cycle characterization of the appliance, as in the case above with the compressor duty cycle. Furthermore, changes in the maxima and minima over time can be used to analyze the appliance in different conditions. For example, a full vending machine may have longer compressor cycles than a nearly-empty vending machine. Such information can be useful in determining for how long an appliance can be shut down without impairing its contents.

According to other embodiments of the present invention, the second section 21B and third section 21C of the support member 21 described herein may be omitted. In such a configuration (which may be used to mechanically support external power-management control subsystems to control power supplied to a bank of appliances in a daisy-chain configuration as described herein), the first section 21A of the support member 21 provides mechanical support to the external power-management control subsystem 11. In addition, the first section 21A can be releasably affixed to the back surface of the appliance 17 (preferably with a releasable velcro strip assembly) for quick and tool-less installation of the external power-management control subsystem supported by the support member 21.

According to alternate embodiments of the present invention, the power-management control subsystem may be integral to the appliance 17. In such a configuration, a support member 21 is provided that has a plurality of sections including a first section 21A, a second section 21B, and a third section 21C as shown in FIG. 1. In this configuration, the first section 21A is releasably affixed to the appliance 17. The second section 21B provides mechanical support to sensor(s) 13, which provide control signals to the integral power-management control subsystem for automatic coupling/decoupling of the power input port of the appliance to/from a power source in response to the control signals provided by sensor(s) 13. In addition, the first section 21A and second section 21B may extend along parallel directions such that the first section 21A can be releasably affixed to the back surface of the appliance 17 (preferably with a releasable velcro strip assembly). In this manner, the first section 21A is disposed along the back surface of the appliance 17, while the second section 21B (and the sensor(s) 13 supported thereon) is disposed above the top surface of the appliance 17. These features enable quick and tool-less installation of the support member 21 and the sensor(s) 13 mechanically supported thereon. Preferably, the support member 21 is a unitary flat piece of hard metal that is bent to form the plurality of sections.

The power-management control system and mechanical support mechanisms described herein advantageously provide efficient power conservation in addition to simple, quick, inexpensive, and error-free installation that does not require tools.

There have been described and illustrated herein several embodiments of a power-management control system and mechanical support mechanisms for use with a vending machine (which may be a refrigerated vending machine). While particular embodiments of the invention have been described, it is not intended that the invention be limited thereto, as it is intended that the invention be as broad in scope as the art will allow and that the specification be read likewise. Thus, the invention applies more generally to other appliances, including those that vary the current they draw in accordance with internal activity. Most electromechanical appliances are in this category.

Moreover, while particular configurations of support structures and control architectures and schemes have been disclosed, it will be appreciated that other configurations could be used as well. It will therefore be appreciated by those skilled in the art that yet other modifications could be made to the provided invention without deviating from its spirit and scope as claimed.

What is claimed is:

1. In a system including an external power-management control subsystem and at least one sensor that cooperate to automatically manage supply of electrical power from a power source to an appliance, an apparatus comprising:
a member having a plurality of sections including a first section which mechanically supports said external power-management control subsystem and a second section which mechanically supports said at least one sensor.

2. The apparatus of claim 1, wherein:
said member has a width and a length, said width substantially smaller than said length.

3. An apparatus according to claim 1, wherein:
said power-management control subsystem comprises
a switch which selectively couples and uncouples said power source to/from said appliance, said switch having a switch control input, and
a controller, operably coupled to an output of said at least one sensor and to said switch control input, said controller adapted to control said switch based upon output of said at least one sensor.

4. An apparatus according to claim 3, wherein:
said at least one sensor comprises an occupancy sensor.

5. An apparatus according to claim 4, wherein:
said occupancy sensor comprises a passive infrared sensor.

6. An apparatus according to claim 3, wherein:
said power-management control subsystem further comprises
a current sensor which provides current-level indications of current through said switch, and
wherein said controller is operably coupled to output of said current sensor, said controller adapted to control said switch based upon output of said current sensor.

7. An apparatus according to claim 3, wherein:
said power-management control subsystem further comprises
timer circuitry whose output is operably coupled to said controller, and
wherein said controller is adapted to control said switch based upon output of said timer circuitry.

8. An apparatus according to claim 3, wherein:
said power-management control subsystem further comprises
time-of-day circuitry whose output is operably coupled to said controller, and
wherein said controller is adapted to control said switch based upon output of said time-of-day circuitry.

9. An apparatus according to claim 3, wherein:
said power-management control subsystem further comprises
a temperature sensor whose output is operably coupled to said controller, and
wherein said controller is adapted to control said switch based upon output of said temperature sensor.

10. An apparatus according to claim 3, wherein:
said at least one sensor comprises a temperature sensor whose output is operably coupled to said controller, and
wherein said controller is adapted to control said switch based upon output of said temperature sensor.

11. An apparatus according to claim 1, wherein:
said member comprises a unitary flat piece of hard metal that is bent to form said plurality of sections.

12. An apparatus according to claim 1, wherein:
said first and second sections extend along parallel directions.

13. An apparatus according to claim 12, further comprising:
means for releasably affixing said first section to said appliance.

14. An apparatus according to claim 13, wherein:
said means for releasably affixing said first section to said appliance comprises VELCRO strips affixed to said first section and said appliance, respectively.

15. An apparatus according to claim 1, further comprising:
electrical wiring affixed to said member which carry control signals between said external power-management control subsystem said at least one sensor.

16. A system, comprising:
a) an external power-management control subsystem and at least one sensor that cooperate to automatically manage supply of electrical power from a power source to an appliance; and
b) a member having a plurality of sections including a first section which mechanically supports said external power-management control subsystem and a second section which mechanically supports said at least one sensor.

17. A system according to claim 16, wherein:
said member has a width and a length, said width substantially smaller than said length.

18. A system according to claim 16, wherein:
said power-management control subsystem comprises
i) a switch which selectively couples and uncouples said power source to/from said appliance, said switch having a switch control input, and
ii) a controller, operably coupled to output of said at least one sensor and to said switch control input, said controller adapted to control said switch based upon output of said at least one sensor.

19. A system according to claim 18, wherein
said at least one sensor comprises an occupancy sensor.

20. A system according to claim 19, wherein:
said occupancy sensor comprises a passive infrared sensor.

21. A system according to claim 18, wherein:
said power-management control subsystem further comprises
iii) a current sensor which provides current-level indications of current through said switch, and
wherein said controller is operably coupled to output of said current sensor, said controller adapted to control said switch based upon output of said current sensor.

22. A system according to claim 18, wherein:
said power-management control subsystem further comprises
iii) timer circuitry whose output is operably coupled to said controller, and
wherein said controller is adapted to control said switch based upon output of said timer circuitry.

23. A system according to claim 18, wherein:
said power-management control subsystem further comprises
iii) time-of-day circuitry whose output is operably coupled to said controller, and
wherein said controller is adapted to control said switch based upon output of said time-of-day circuitry.

24. A system according to claim 18, wherein:
said power-management control subsystem further comprises:
iii) a temperature sensor whose output is operably coupled to said controller, and
wherein said controller is adapted to control said switch based upon output of said temperature sensor.

25. A system according to claim 18, wherein:
said at least one sensor comprises a temperature sensor whose output is operably coupled to said controller, and
wherein said controller is adapted to control said switch based upon output of said temperature sensor.

26. A system according to claim 16, wherein:
said member comprises a unitary flat piece of hard metal that is bent to form said plurality of sections.

27. A system according to claim 16, wherein:
said first and second sections extend along parallel directions.

28. A system according to claim 27, further comprising:
means for releasably affixing said first section to said appliance.

29. A system according to claim 28, wherein:
said means for releasably affixing said first section to said appliance comprises VELCRO strips affixed to said first section and said appliance, respectively.

30. A system according to claim 16, further comprising:
electrical wiring affixed to said member which carries control signals between said external power-management control subsystem said at least one sensor.

31. In a system including an external power-management control subsystem and at least one sensor that cooperate to automatically manage supply of electrical power from a power source to an appliance, an apparatus comprising:
a member having first means for mechanically supporting said external power-management control subsystem and second means for mechanically supporting said at least one sensor.

32. The apparatus of claim 31, wherein:
said member has a width and a length, said width substantially smaller than said length.

33. An apparatus according to claim 31, wherein:
said power-management control subsystem comprises
a switch for selectively coupling and uncoupling said power source to/from said appliance, said switch having a switch control input, and
a controller, operably coupled to output of said at least one sensor and to said switch control input, for controlling said switch based upon output of said at least one sensor.

34. An apparatus according to claim 33, wherein:
said at least one sensor comprises an occupancy sensor.

35. An apparatus according to claim 34, wherein:
said occupancy sensor comprises a passive infrared sensor.

36. An apparatus according to claim 33, wherein:
said power-management control subsystem further comprises
a current sensor for providing current-level indications of current through said switch, and
wherein said controller is operably coupled to output of said current sensor and is adapted to control said switch based upon output of said current sensor.

37. An apparatus according to claim 33, wherein:
said power-management control subsystem further comprises
timer circuitry whose output is operably coupled to said controller and
wherein said controller is adapted to control said switch based upon output of said timer circuitry.

38. An apparatus according to claim 33, wherein:
said power-management control subsystem further comprises
time-of-day circuitry whose output is operably coupled to said controller, and
wherein said controller is adapted to control said switch based upon output of said time-of-day circuitry.

39. An apparatus according to claim 33, wherein:
said power-management control subsystem further comprises
a temperature sensor whose output is operably coupled to said controller, and
wherein said controller is adapted to control said switch based upon output of said temperature sensor.

40. An apparatus according to claim 33, wherein:
said at least one sensor comprises a temperature sensor whose output is operably coupled to said controller, and
wherein said controller is adapted to control said switch based upon output of said temperature sensor.

41. An apparatus according to claim 31, wherein:
said member comprises a unitary flat piece of hard metal that is bent to form said plurality of sections.

42. An apparatus according to claim 31, wherein:
said first and second sections extend along parallel directions.

43. An apparatus according to claim 42, further comprising:
means for releasably affixing said first section to said appliance.

44. An apparatus according to claim 43, wherein:
said means for releasably affixing said first section to said appliance comprises VELCRO strips affixed to said first section and said appliance, respectively.

45. In a system including an external power-management control subsystem and at least one sensor that cooperate to automatically manage supply of electrical power from a power source to an appliance, an apparatus comprising:
a member which mechanically supports said external power-management control subsystem.

46. The apparatus of claim 45, wherein:
further comprising means for releasably affixing said member to said appliance.

47. An apparatus according to claim 45, wherein:
said power-management control subsystem comprises
a switch which selectively couples and uncouples said power source to/from said appliance, said switch having a switch control input, and
a first controller, operably coupled to an output of said at least one sensor and to said switch control input, said first controller adapted to control said switch based upon output of said at least one sensor.

48. An apparatus according to claim 47, wherein:
output of said at least one sensor is coupled to a second controller, which forwards sensor status information derived said output to said first controller over a data communication link therebetween.

49. An apparatus according to claim 48, wherein:
said at least one sensor comprises an occupancy sensor.

50. An apparatus according to claim 49, wherein:
said occupancy sensor comprises a passive infrared sensor.

51. An apparatus according to claim 48, wherein:
said at least one sensor comprises an ambient temperature sensor.

52. An apparatus according to claim 47, wherein:
said power-management control subsystem further comprises
a current sensor which provides current-level indications of current through said switch, and
wherein said first controller is operably coupled to output of said current sensor, said first controller adapted to control said switch based upon output of said current sensor.

53. An apparatus according to claim 47, wherein:
said power-management control subsystem further comprises
timer circuitry whose output is operably coupled to said first controller, and
wherein said first controller is adapted to control said switch based upon output of said timer circuitry.

54. An apparatus according to claim 47, wherein:
said power-management control subsystem further comprises
time-of-day circuitry whose output is operably coupled to said first controller, and
wherein said first controller is adapted to control said switch based upon output of said time-of-day circuitry.

55. An apparatus according to claim 46, wherein:
said means for releasably affixing said member to said appliance comprises VELCRO strips affixed to said member and said appliance, respectively.

56. In a system including a power-management control subsystem and at least one sensor that cooperate to automatically manage supply of electrical power from a power source to an appliance, an apparatus comprising:
a member having a plurality of sections including a first section which mechanically supports said at least one sensor.

57. The apparatus of claim 56, wherein:
said member has a width and a length, said width substantially smaller than said length.

58. An apparatus according to claim 56, wherein:
said power-management control subsystem comprises
a switch which selectively couples and uncouples said power source to/from said appliance, said switch having a switch control input, and
a controller, operably coupled to an output of said at least one sensor and to said switch control input, said controller adapted to control said switch based upon output of said at least one sensor.

59. An apparatus according to claim 58, wherein:
said at least one sensor comprises an occupancy sensor.

60. An apparatus according to claim 59, wherein:
said occupancy sensor comprises a passive infrared sensor.

61. An apparatus according to claim 58, wherein:
said power-management control subsystem further comprises
a current sensor which provides current-level indications of current through said switch, and
wherein said controller is operably coupled to output of said current sensor, said controller adapted to control said switch based upon output of said current sensor.

62. An apparatus according to claim 58, wherein:
said power-management control subsystem further comprises
timer circuitry whose output is operably coupled to said controller, and
wherein said controller is adapted to control said switch based upon output of said timer circuitry.

63. An apparatus according to claim 58, wherein:
said power-management control subsystem further comprises
time-of-day circuitry whose output is operably coupled to said controller, and
wherein said controller is adapted to control said switch based upon output of said time-of-day circuitry.

64. An apparatus according to claim 58, wherein:
said power-management control subsystem further comprises
a temperature sensor whose output is operably coupled to said controller, and
wherein said controller is adapted to control said switch based upon output of said temperature sensor.

65. An apparatus according to claim 58, wherein:
said at least one sensor comprises a temperature sensor whose output is operably coupled to said controller, and
wherein said controller is adapted to control said switch based upon output of said temperature sensor.

66. An apparatus according to claim 56, wherein:
said power-management control subsystem is integral to said appliance.

67. An apparatus according to claim 56, wherein:
said member comprises a unitary flat piece of hard metal that is bent to form said plurality of sections.

68. An apparatus according to claim 56, wherein:
said member comprises a second section that extends along parallel direction to said first section.

69. An apparatus according to claim 68, further comprising:
means for releasably affixing said second section to said appliance.

70. An apparatus according to claim 69, wherein:
said means for releasably affixing said second section to said appliance comprises VELCRO strips affixed to said second section and said appliance, respectively.

71. An apparatus according to claim 56, further comprising:
electrical wiring affixed to said member which carry control signals between said power-management control subsystem said at least one sensor.
